(19) United States
(12) Patent Application Publication
(10) Pub. No.: US 2018/0288706 A1
(43) Pub. Date: Oct. 4, 2018

(54) WIRELESS COMMUNICATION DEVICE, SYSTEM AND METHOD TO PROVIDE AN OPERATIONAL CYCLIC PREFIX LENGTH TO DECODE A WAKE-UP PACKET

(71) Applicant: Intel Corporation, Santa Clara, CA (US)

(72) Inventors: Juan Fang, Portland, OR (US); Shahrnaz Azizi, Cupertino, CA (US); Minyoung Park, Portland, OR (US)

(73) Assignee: Intel Corporation, Santa Clara, CA (US)

(21) Appl. No.: 15/473,082

(22) Filed: Mar. 29, 2017

(51) Int. Cl. H04W 52/02; H04L 27/26; H04W 28/06

(52) U.S. Cl. CPC H04W 52/0235; H04W 84/12; H04W 28/065; H04L 27/2607

(57) ABSTRACT

A wireless communication system, system and method. A wireless communication device comprises a memory, and processing circuitry including logic. The processing circuitry is to decode a wake-up payload, when a main radio associated with the device is in a sleep state, using an operational cyclic prefix length for the packet. The operational cyclic prefix length may be one of a fixed cyclic prefix length, a cyclic prefix length used for a last packet transmission by the main radio, and a selected cyclic prefix length determined by the processing circuitry. The processing circuitry may further cause a wake-up of the main radio based on the wake-up payload to allow the main radio to process a subsequent packet after waking up.

### TECHNICAL FIELD

Embodiments relate to wireless communication in a low power setting. Some demonstrative embodiments relate to a construction of low-power wake-up (LP-WU) packet for waking up a wireless local-area network (WLAN) device with low-power wake-up receiver (LP-WUR) within an IEEE 802.11 network.

### BACKGROUND

Low power wireless devices are enabling many wireless devices to be deployed in wireless local-area network (WLAN). However, the low power wireless devices are bandwidth constrained and power constrained, and yet may need to operate with both newer protocols and with legacy station protocols. In addition, low power wireless devices are not able to decode low power wake-up payloads addressed to them where a cyclic prefix length of the wake-up payload may be unknown to them.

### BRIEF DESCRIPTION OF THE DRAWINGS

The present disclosure is illustrated by way of example and not limitation in the figures of the accompanying drawings, in which like references indicate similar elements and in which:

FIG. 1 illustrates a basic service set (BSS) including an access point (AP), two stations (STAs) each including Low-Power Wake-Up Receivers, and a legacy STA;

FIG. 2 illustrates a Low Power Wake-Up (LP-WU) packet plus a legacy preamble in the time domain in accordance with some demonstrative embodiments;

FIG. 3 illustrates a radio architecture for a STA or an AP from the BSS of FIG. 1 in accordance with some demonstrative embodiments;

FIG. 4 illustrates a LP-WU signal multiplexed into an 802.11ax signal in the time domain;

FIG. 5 illustrates a product of manufacture in accordance with some demonstrative embodiments; and

FIG. 6 illustrates a flow-chart of a method according to some demonstrative embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some demonstrative embodiments may be included in, or substituted for, those of other embodiments. Embodiments set forth in the claims encompass all available equivalents of those claims.

To reduce power consumption in a basic service set (BSS), the idea of using a low-power wake-up receiver (LP-WUR) in Wi-Fi devices has been developed, and has been introduced into the Institute of Electrical and Electronics Engineers (IEEE) 802.11 community in late 2015. Since that time, LP-WUR has received much attention. Recently, a Study Group (SG) named Wake-Up Receiver (WUR) SG was formed under IEEE 802.11 to study and begin standardization of the new wireless communication protocol as a new amendment to the 802.11 standard specification. The WUR SG has been approved and is slated to be replaced by the 802.11TGba Task Group. The WUR provides an ultra-low power solution (for example about 100 μW in an active state) for an always on Wi-Fi or Bluetooth (BT) connectivity of wearable, Internet-of-Things (IoT) or other emerging devices that may be densely deployed. Although 100 μW is mentioned here, it is merely an example of the power used in a listen state. Embodiments encompass LP-WURs that use lower or high power, such as, for example, a few hundred μW. Hereinafter, LP-WUR may be used to refer to the 802.11ba/LP-WUR wireless communication protocol, or to LP-WU functionality (that is, functionality according to principles within the LP-WUR wireless communication protocol), and the meaning of the acronym will be clear from the context within which it is used.

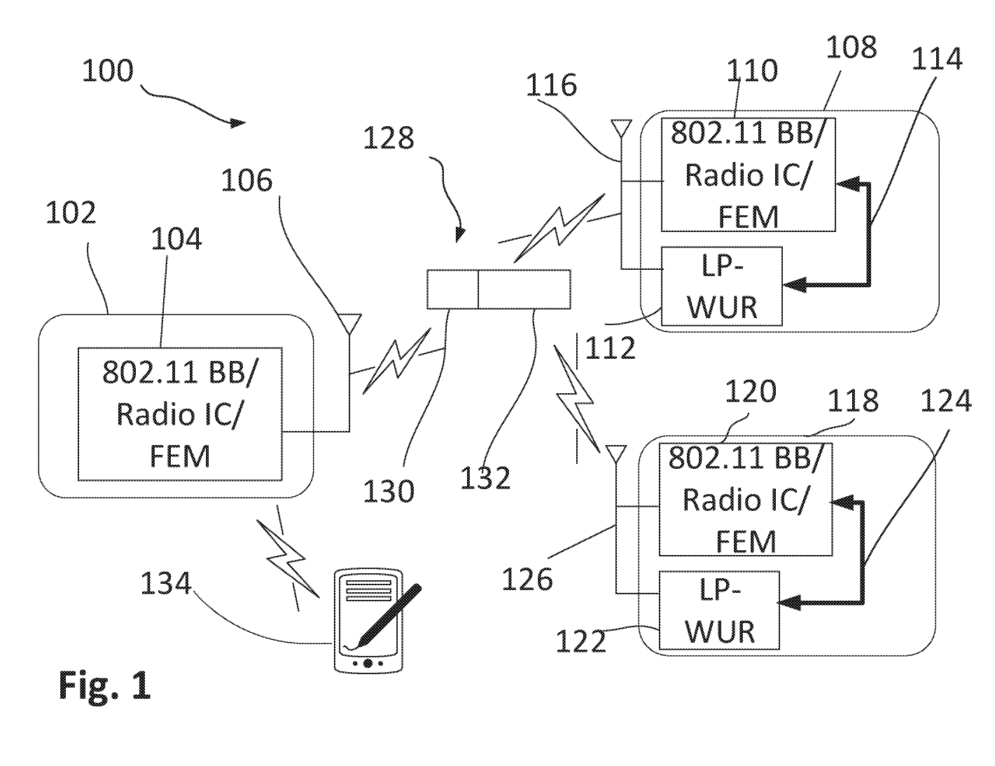

To better understand the concept behind LP-WUR, we refer to FIG. 1, which depicts a Wireless Local Area Network (WLAN) BSS 100 including an AP 102, two LP-WUR compliant STAs 108 and 118, and a non-LP-WUR STA 134. The AP and STAs may, regardless of compliance with LP-WUR, use one of the IEEE 802.11 wireless communication protocols to transmit and receive. The AP and STAs may use other communications protocols as well as any of the IEEE 802.11 protocols. The IEEE 802.11 protocols may include Wi-Fi protocols, that is, for example, the IEEE 802.11ax protocol, the 802.11ac protocol, the 802.11-2012 protocol, the 802.11n protocol, the 802.11a protocol, the 802.11g protocol, and/or any other 802.11 protocol. The IEEE 802.11 protocols may include using orthogonal frequency division multiple-access (OFDMA), time division multiple access (TDMA), and/or code division multiple access (CDMA). The IEEE 802.11 protocol may include space-division multiple access (SDMA) and/or multiple-user multiple-input multiple-output (MU-MIMO).

The AP and each of STA 108 and 118 are shown as including an 802.11 radio system such as 802.11 radio system 104 of AP 102, 802.11 radio system 110 of STA 108 and 802.11 radio system 120 of STA 118 (the radio system for legacy STA 134 has not been shown, although a person skilled in the art would readily understand that it would be present). Hereinafter, “radio” and “radio system” may be used interchangeably. Each radio system may include one or more baseband processors, one or more radio integrated circuits, and one or more radio front end modules as would be recognized by one skilled in the art. In addition, each radio system may be coupled to one or more antennas. For example, radio system 104 may be coupled to antenna 106 to allow transmission and reception of radio signals by AP 102. Radio system 110 may be coupled to antenna 116 to allow transmission and reception of radio signals by STA 108 and radio system 110 may be coupled to antenna 116 to allow transmission and reception of radio signals by STA 108. Although each radio system is shown in FIG. 1 as being coupled to one antenna, it is to be understood that embodiments apply to APs or STAs that include one or more antennas coupled to the same radio system, and one or more antennas coupled to various radio systems that are compliant with protocols other than 802.11. Embodiments include within their scope the provision of various components of a radio system on a single physical integrated circuit (or card), or on multiple integrated circuits as would be recognizable by one skilled in the art.

Referring still to FIG. 1, STAs 108 and 118 each include a LP-WUR that is coupled to their 802.11 radio systems 110. It is to be noted that, although FIG. 1 suggests the LP-WUR as potentially being physically distinct from the 802.11 radio system in each STA, embodiments include within their scope various levels of integration between the LP-WUR and the 802.11 radio system. For example, the LP-WUR could include at least one of a LP-WU baseband processor, a LP-WU radio integrated circuit (IC), and a LP-WU front-end module (FEM) that is integrated with a respective one of the non-LP-WU 802.11 baseband processor, radio IC and FEM.

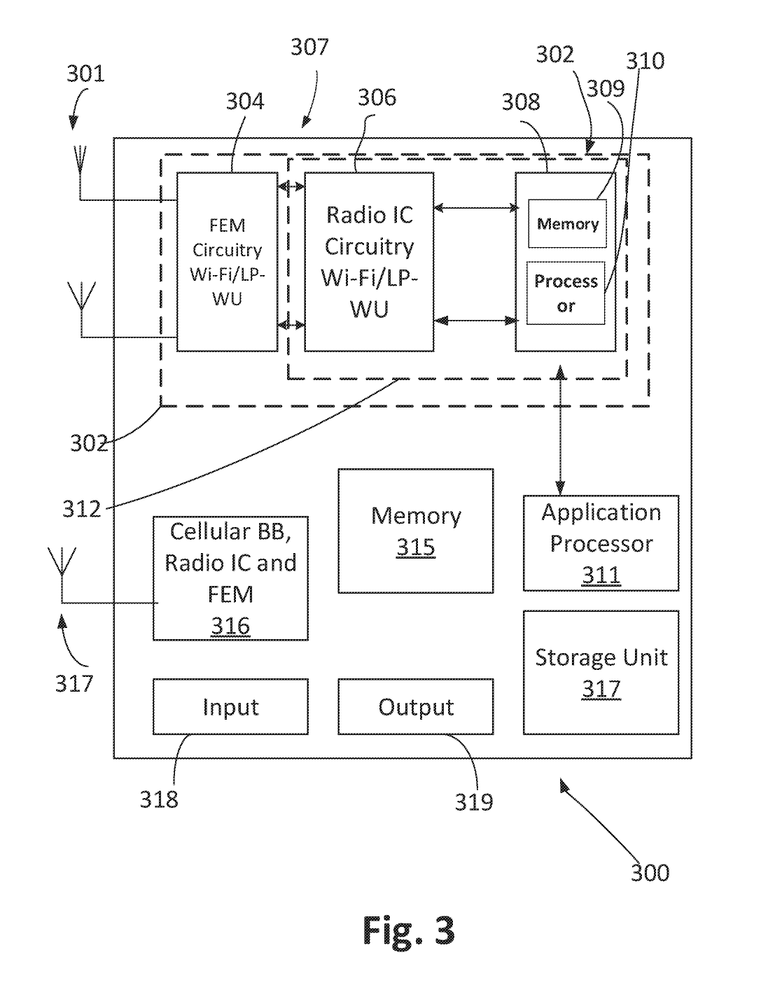

With respect to AP 102, FIG. 1 does not show a LP-WUR that is coupled to the 802.11 radio system. This is not to suggest that AP may not include a LP-WUR, but merely that, with respect to the operations to be described further below with respect to BSS 100 of FIG. 1, the presence of a LP-WUR as part of AP 102 would not be relevant, because no LP-WU packets would be sent to AP 102 during those operations to be described, but would rather be sent by AP 102 to an LP-WUR of another STA, for example, either STA 108 or STA 118. The above having been said, the 802.11 radio system of AP 102, in the shown embodiment, would have LP-WU functionality in that it would be configured to at least send LP-WU packets to other LP-WUR compliant STAs. Further details regarding an embodiment for an AP or a STA that can provide LP-WU functionality will be provided with respect to FIG. 3 below.

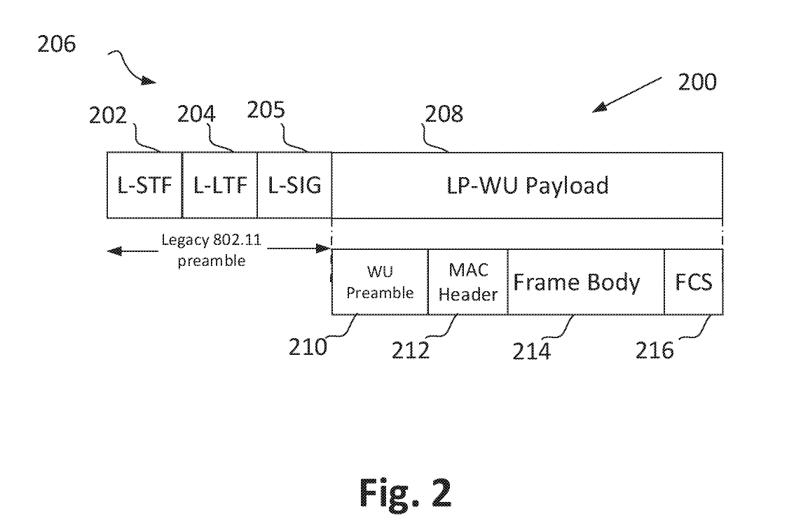

Referring still to FIG. 1, AP 102 is shown as having sent a LP-WU packet 128 addressed to STA 108. The LP-WU packet 128 includes a legacy preamble portion 130, and a wake-up portion or wake-up payload 132. Details regarding an embodiment of the packet structure for LP-WU packet 128 will be provided with respect to FIG. 2 below. A purpose of LP-WU packet 128 is to alert or trigger a LP-WUR to wake up its main radio system, such as, for example, an 802.11ax, 802.11ac, 802.11-2012, 802.11n or other radio system. By “main radio system,” what is meant here is a radio system that operates at a higher power level and processes higher modulation rate symbols than that applicable to its associated wake-up radio system, and that can receive and process user data packets. For example, packet 128 as sent by AP 102 may be addressed to LP-WUR 112 of STA 108 or to LP-WUR 122 of STA 118 (or potentially both as a multicast packet) to signal to either or both LP-WUR to wake up its/their associated main 802.11 radio system so that the main radio system(s) can subsequently receive user data packets sent by AP 102, and specifically sent by radio system 104 of AP 102. The main radio system is in this way to remain in the off state to conserve power, while the LP-WUR is to remain in an on state to receive LP-WU packets. A signaling between the LP-WUR and its associated main radio system is depicted in FIG. 1 by way of a signal connection 114 and 124 corresponding respectively to a connection between LP-WUR 112 and radio system 110 on the one hand, and between LP-WUR 122 and radio system 120 on the other hand. The connection may for example be wired or wireless, and is to allow a wake-up signal to be sent from the LP-WUR to its main radio system to wake up the main radio system for reception of data packets.

It is to be appreciated that LP-WUR may be configured as a simple receiver without including a transmitter, and further without the capability of processing user data packets per se. It may remain on/active as long as the main radio system is off, and may be inactive when the main radio system is on/active. LP-WU packets may be generated by an AP using a simple modulation scheme such as an On-Off-Keying (OOK) modulation scheme, and a narrow bandwidth such as, for example, a bandwidth of less than about 5 MHz, for example, about 4.06 MHz or about 2.031 MHz. A target transmission range of a LP-WU packet may be similar to a transmission range for today's 802.11 compliant transmitters, that is, up to a few hundred meters, such as, for example, up to about 250 m to 300 m, or more.

A concept for LP-WUR has been contemplated which is based on the 802.11a/g/n/ac/ax specifications (that is, some examples of Wi-Fi specifications, although “Wi-Fi” as used herein is to encompass next generations of 802.11 subsequent to 802.11ax). LP-WUR may use a symbol duration of 3.2 μsec+Cyclic Prefix (CP) Orthogonal Frequency Division Multiplexing (OFDM) with a 312.5 KHz tone spacing. LP-WUR further may use 13 subcarriers (4.06 MHz) per symbol. For example, a LP-WU signal waveform may have 1 bit per symbol period, with each symbol period achieving a rate of about 250 kbps.

Referring next to FIG. 2, a LP-WU packet 200 according to an exemplary embodiment is shown along with the legacy preamble portion 206 and a LP-WU payload 208. LP-WU packet 200 may, for example, correspond to the LP-WU packet 128 of FIG. 1, legacy preamble portion 206 in FIG. 2 may correspond to legacy preamble portion 130 of FIG. 1, and LP-WU payload 208 of FIG. 2 may correspond to wake-up portion 132 of FIG. 1. The legacy preamble portion 206 may be transmitted on a channel bandwidth in compliance with the protocol used by the main radio system of the AP sending the LP-WU packet, such as with 802.11ax, and the payload 208 may be transmitted on a 2.03125 MHz, 4.0625 MHz, or 8.28125 MHz channel in compliance with LP-WU. Legacy preamble portion 206 may include a legacy short-training field (L-STF) 202, a legacy long training field (L-LTF) 204, and a legacy signal (L-SIG) field 205. In some demonstrative embodiments, a LP-WUR may ignore the legacy preamble 206. A purpose of the legacy preamble 206 would be to allow third-party 802.11 STAs to detect the beginning of the LP-WU packet through L-STF 202, and the end of the packet through information within L-SIG 205. Thus, a third-party 802.11 STA, having received the legacy preamble 206, would know to set its Network Allocation Vector (NAV) and to refrain from transmitting until the end of the LP-WU packet. The L-SIG may convey information regarding a length of the LP-WU payload 308. In this way, a LP-WU packet would have a structure that would allow coexistence with non-LP-WUR capable STAs.

Referring still to FIG. 2, LP-WU payload 208 may include a wake-up preamble 210, a MAC header 212, a frame body 214, and a frame check sequence field (FCS) 216 for error correction. The LP-WU payload may include information in a field, such as in the MAC header 212 or in the frame body 214, regarding an identifier/address for the STA for which the LP-WU packet is destined.

In some demonstrative embodiments, LP-WU payload 208 may use a different modulation as compared with the modulation of the preamble, for example, a lower modulation. For example, LP-WU payload 208 may be modulated using OOK modulation, while the legacy preamble may be OFDM modulated using binary phase shift keying (BPSK), although embodiments are not so limited.

The wake-up preamble 210 may include a sequence of wake-up pulses, and may be generated by OOK modulation of a pattern (e.g., [1 1 0 . . . 1 0]). According to an exemplary embodiment, the MAC header 212 may be a header that includes a source address or identifier for the source generating the pulse (for example, AP 102 of FIG. 1), or a destination address or identifier for the STA to which the LP-WU packet is destined or both (for example STA 108 of FIG. 1). In the alternative, the frame body or LP-WU payload 208 may be the body of the frame that includes one or more of the above identifiers. The identifier may be an identifier of one or more LP-WURs within STA(s) to which the LP-WU packet may be addressed. The FCS 216 may include information for a LP-WUR to check the integrity of the payload 208.

As noted previously, packet 200 may be used to cause a wake-up of the main radio system, such as an 802.11ax radio, such that this main radio system could, after waking up, demodulate subsequent OFDMA signals from the transmitter that sent the multiplexed OFDMA signal including the OOK LP-WU signal, and/or from other transmitters.

Considering now FIG. 1 in conjunction with FIG. 2, LP-WU packet 128 may be addressed to STA 108 to wake up main radio system 110 through LP-WUR 112. The legacy preamble portion 130 of the LP-WU packet 128 may be used by STA 118 and by STA 134, in this example third-party STAs, to set their respective NAVs, in part through information regarding the length of wake-up packet 128 provided in the L-SIG of preamble 130, corresponding for example to L-SIG 205 of FIG. 2. However, the legacy preamble portion 130 is not amenable to being decoded by an LP-WUR (in part because it is a different signal waveform using a different modulation). Therefore, although legacy preamble 130 may allow coexistence between AP 102 and STAs 118 and 134, no part of the wake-up packet as shown in FIG. 1 would allow the LP-WUR of STA 108 to be aware of the CP length (CP) length of the LP-WU packet, although the LP-WUR would need to have the CP length in order to determine the symbol lengths within the LP-WUR packet. It is noted that, in the context of the instant disclosure, “CP” or “CP” is used to have the same meaning as “guard band” or “GI.”

By way of example, the 802.11n amendment defines different CP lengths for 802.11n OFDM symbols, which CP lengths are selected from 0.4 μsec, and 0.8 μsec, and the 802.11ax amendment defines different CP lengths for 802.11ax OFDM symbols, which CP lengths are selected from 0.8 μsec, 1.6 μsec and 3.2 μsec. These CP lengths are configured by the 802.11 a/g/n/ac/ax transmitters. However, a CP length for the LP-WU packet is not included in the LP-WU preamble, but would be needed for the LP-WUR receiver to determine the symbol duration for the LP-WU packet in order to decode or demodulate the packet. In the instant disclosure three embodiments are proposed to allow the LP-WUR to decode the LP-WU packet using an operational CP length. An operational CP length as used herein refers to a CP length that would allow the LP-WUR to correctly decode the LP-WU packet, and that may or may not correspond to the actual CP length of the LP-WU packet, as will become apparent from the detailed description to follow. A first demonstrative embodiment includes using a fixed CP length to decode the wake-up payload. A second demonstrative embodiment includes using the same CP length as the CP length used by the main radio system for its last packet transmission as the operational CP length. A third embodiment includes determining the operational CP length by performing hypothesis testing during preamble detection of the wake-up payload using cross-correlation with different CP lengths generated by the LP-WUR. The operational CP length would then correspond to a selected CP length that is determined by the wake-up receiver.

Some demonstrative embodiments contemplate allowing the LP-WUR to know the operational CP length for a received wake-up payload.

According to the first embodiment, a wake-up radio, such as a LP-WUR, would know that all wake-up payloads would have a uniform or fixed CP length. The wake-up radio would, as a result, deem the operational CP length to be equal to the fixed CP length, and would decode the wake-up payload using the fixed CP length. To enable operation in a variety of scenarios, such as both indoor and outdoor scenarios, one embodiment contemplates that the fixed CP length would be equal to a longest CP length possible in the given environment, such as the longest CP length supported for a packet to be demodulated by the main radio system associated with the wake-up radio. Therefore, by way of example, the fixed CP length may be equal to a longest CP length supported for an 802.11n packet if the main radio system supports 802.11n. Although the latter embodiment may increase overhead due to the use of a longest CP length unnecessarily, this first embodiment in general provides the advantage that it would not necessitate separate CP lengths and symbol durations for broadcasted and multi-casted wake-up packets. Otherwise, for wake-up payloads to be sent to multiple STAs, different CP lengths may be needed based for example on the expected delay spread between the transmitter and each STA to receive a wake-up payload.

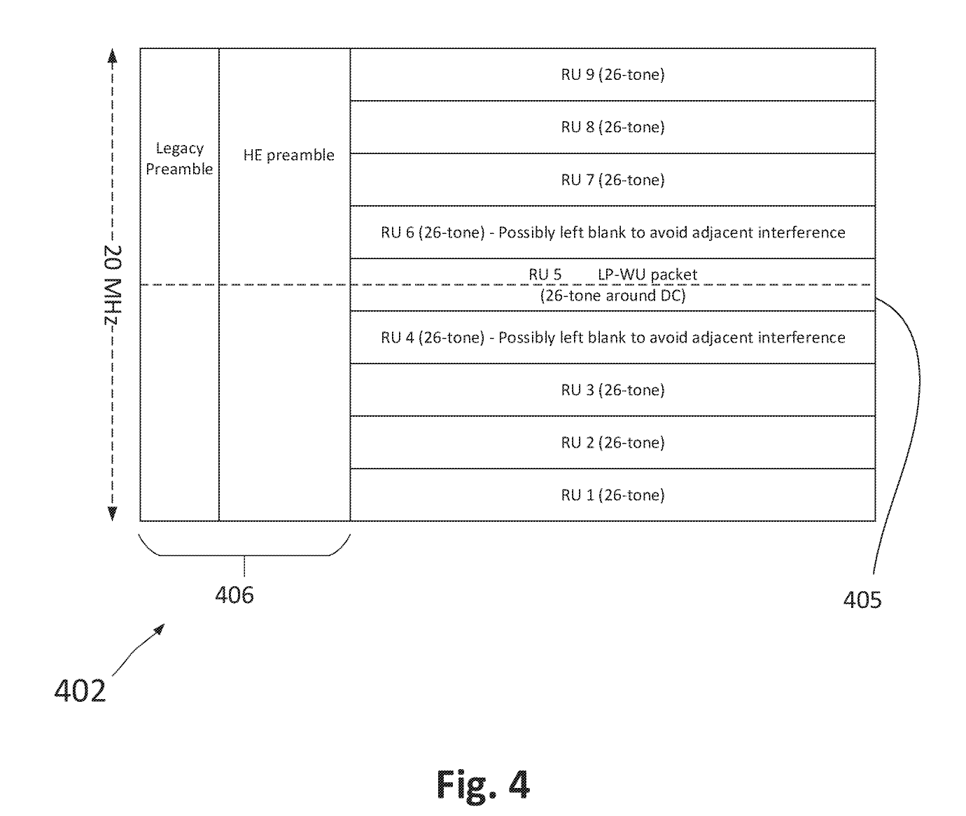

According to the second and third embodiments, the CP lengths used for the LP-WU packet symbols sent by the transmitter to the wake-up receiver may vary, adaptively, for example based on expected delay spread and/or based on the varying CP lengths used in an OFDMA packet structure into which an LP-WU payload may be multiplexed (such as will be described in more detail with respect to FIG. 4 below).

If the performance of a wake-up receiver is expected to be affected by inter-symbol interference due to delay spread, the transmitter of the wake-up packet may use different CP lengths for different anticipated delay spread scenarios, as would be recognized by one skilled in the art. By way of example, if the transmitter of the LP-WU packet, for example AP 102 of FIG. 1, and device including the LP-WUR and associated main radio system, for example STA 108 of FIG. 1, move from an indoor environment to an outdoor environment, to mitigate inter-symbol interference, the transmitter of the wake-up payload could use a different CP length for the wake-up payload, and/or the main radio system of the device could use a different CP length for packets it sends, as compared with the CP length used for packets in an indoor setting. For example, the transmitter or device may use a longer CP length in an outdoor environment.

If the LP-WU signals of a LP-WU packet are multiplexed into an OFDMA packet structure, for example the OFDMA packet structure of an 802.11ax communication (with further details set forth with respect to FIG. 4 below), the CP length of the LP-WU packet would change based on a changing CP length of the OFDMA packet. For example, AP 102 of FIG. 1 could be sending a downlink (DL) multi-user (MU) multiple input multiple output (MIMO), hereinafter MU-MIMO transmission, to STAs 118 and 134 using resource units (RUs) within an OFDMA packet structure, and could use an RU of the OFDMA packet structure to multiplex the LP-WU signal, the LP-WU signal being addressed to STA 108 of FIG. 1. For such multiplexing, to avoid interference between the LP-WU signals in one RU, such as a central RU of the OFDMA packet structure, and the OFDMA signals in other RUs of the OFDMA packet structure, the LP-WU packet would need to have its symbols aligned with the OFDMA symbols into which it is multiplexed. As a result, the LP-WU would for example be using the same CP length as that used by the OFDMA symbols addressed to STAs 118 and 134. However, the CP length of the OFDMA symbols could be subject to change as supported for the OFDMA symbols, for example as supported for 802.11ax OFDMA symbols. Such variations in the CP length would necessitate a mechanism to allow the LP-WUR to use a CP length that would allow it to correctly decode the LP-WU packet addressed to it.

In the case of varying CP lengths for the wake-up packet, according to the second embodiment, the wake-up receiver may use the CP length of the last packet sent by the main radio system associated with it as the operational CP length to decode wake-up payload, and then use the wake-up payload to wake up the main radio system. The above may be implemented for example where a transmitter of an LP-WU payload, having been previously informed by the main radio system associated with the LP-WUR receiver, that the main radio system is to enter a sleep state, may use the CP length associated with the last packet it received from the main radio system to transmit the LP-WU payload to the LP-WUR associated with that main radio system. In such a case, prior to going to sleep, the main radio system may communicate its last used CP length to the LP-WUR with which it is associated. Such communication may happen in a number of ways, and may, for example, result in the CP length value for the last packet by the main radio system being stored in a buffer or memory of the LP-WUR for later use as noted above.

According to the third embodiment, which, as noted above, is related to a scenario involving varying CP lengths being used for the wake-up payload, the wake-up receiver may determine the operational CP length to be used to decode a wake-up payload sent to it. Such determination may take place for example by way of hypothesis testing, such as by way of a LP-WUR using local preambles with differing/distinct CP lengths, and comparing the cross correlation of the local preambles with the preamble of the wake-up payload. The LP-WUR would then select, as the operational CP length, the CP length of the local preamble that has the highest cross correlation with the preamble of the received wake-up payload. In this way, the operational CP length would correspond to the CP length selected based on the cross correlation (or to a selected CP length), and information of the operation CP length of the wake-up payload could then be used to decode the wake-up payload.

Further details regarding the first, second and third embodiments will be provided further below.

Advantageously, according to the above mechanism, a wake-up radio system, such as a LP-WUR, can use an operational CP length in order to correctly decode or demodulate wake-up packets that it receives, and can therefore wake-up the main radio accordingly. Embodiments therefore advantageously allow the use of operational CP lengths even where delay spread may be an issue, and even where a wake-up packet is multiplexed into an OFDMA packet structure (in which case its CP length may change as a result of potentially changing CP lengths from one OFDMA packet structure to the next).

Referring back to FIG. 1, STAs 108, 118 and 134 may include wireless transmit and receive devices such as cellular telephones, smart telephones, handheld wireless devices, wireless glasses, wireless watches, wireless personal devices, tablets, or other devices that may be transmitting and receiving using the any of the IEEE 802.11 protocols such as IEEE 802.11ax or another wireless communication protocol. In some demonstrative embodiments, STAs 108, 118 and/or 134 may be compliant with the 802.11ax communication protocol, and may be termed high efficiency (HE) stations. An 802.11ax or High Efficiency Wi-Fi (HEW) signal may be communicated on a subchannel that may have a bandwidth of 20 MHz, 40 MHz, or 80 MHz, 160 MHz, or 320 MHz contiguous bandwidths or an 80+80 MHz (160 MHz) non-contiguous bandwidth. Hereinafter, “HEW” and “802.11ax” may be used interchangeably. In some demonstrative embodiments, the bandwidth of a HEW subchannel may be 2.03125 MHz, 4.0625 MHz, 8.28125 MHz, a combination thereof, or another bandwidth that is less or equal to the available bandwidth may also be used. The subchannel may include a number of tones or tones, such as 26, and these tones may include a combination of data tones and other tones. The other tones may include DC nulls, guard intervals, or may be used for any purpose other than carrying data.

A HEW packet may be configured for transmitting a number of spatial streams, which may be in accordance with MU-MIMO. In other embodiments, the AP and STAs in FIG. 1 may also implement different technologies such as code division multiple access (CDMA) 2000, CDMA 2000 1×, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), Bluetooth®, or other technologies.

In some demonstrative embodiments, STA 108, 118 and/or 134 may include Internet-of-Things (IoT) devices that operate in accordance with IEEE 802.11ax or another wireless communication protocol of 802.11. The IoT devices may operate on a smaller sub-channel than the 802.11ax devices. For example, the IoT devices may operate on 2.03125 MHz, 4.0625 MHz, or 8.28125 MHz channels/subchannels. The IoT devices may be sensors designed to measure one or more specific parameters of interest such as temperature sensor, humidity, or location-specific sensors. IoT devices may be connected to a sensor hub (not illustrated), and may upload data to the sensor hub. The sensor hub may upload the data to an access gateway (not illustrated) that may connect several sensor hubs to a cloud sever. The AP may act as the access gateway in accordance with some demonstrative embodiments. The AP may act as the sensor hub in accordance with some demonstrative embodiments. In some other demonstrative embodiments, the IoT devices may need to consume very low average power in order to perform a packet exchange with the AP.

The AP may transmit a LP-WU payload to various ones of the stations that have LP-WUR functionality. A LP-WUR included in a STA, such as LP-WUR 112 or 122, may operate on a sub-channel smaller than the operating range of the AP. Stations that are not a recipient of the LP-WUR packet should refrain from communicating, based on the legacy preamble portion 130 of the LP-WU packet as noted previously.

A STA would not know whether the packet is addressed to it until it decodes the LP-WU payload. The LP-WU preamble allows LP-WU packet acquisition, in that, through cross correlation that would yield a value larger than a predetermined threshold value, it would assume that the packet received is in fact a LP-WU packet. The STA, may, according to some demonstrative embodiments, generate several local preambles with different CP lengths to check the cross correlation with the received LP-WU preamble. If the STA should arrive at a value larger than a predetermined threshold value for a number of CP lengths as a result of the cross-correlation, the LP-WUR may use the CP with a largest cross correlation as the operative CP length of the LP-WU packet. The STA may then decode the LP-WU payload using the operative CP length.

In accordance with some demonstrative embodiments, with the assumption that the LP-WU packet 128 is addressed by AP 102 to STA 108, LP-WUR 112 of STA 108 may receive the LP-WU packet 128, use an operational CP length as noted above with respect to the first, second and/or third embodiment, decode it, and consequently wake up the main radio system of STA 108, which then may contend for the wireless medium with STA 118 and STA 134, and receive and decode one or more subsequent packets from AP 102. STAs 118 and 134 would have used the legacy preamble 130 to determine the length of the packet in order to set their network allocation vectors, and STA 108 would have ignored the legacy preamble 130, having determined that the LP-WU packet 128 is addressed to it.

In some demonstrative embodiments, after the main radio system of STA 108 is woken up, it may communicate with the AP in accordance with a non-contention based access technique after being woken up and obtaining the UL transmit configuration from a trigger packet which may indicate an uplink (UL) UL-MU-MIMO and/or UL OFDMA control period.

In some demonstrative embodiments, a multiple-access technique used during a HEW control period may be a scheduled OFDMA technique, although this is not a requirement. In some demonstrative embodiments, the multiple access technique may be a time-division multiple access (TDMA) technique or a frequency division multiple access (FDMA) technique. In some demonstrative embodiments, the multiple access technique may be a space-division multiple access (SDMA) technique.

As used in this disclosure, “tone” and “subcarrier” are used interchangeably. Moreover, when “at least one of” a given set or list of items connected with “and” is mentioned herein, what is meant is a reference to either one of the noted items, or any combination of the items. For example, as used herein, “at least one of A, B and C” means “A, or B, or C, or A and B, or A and C, or B and C, or A and B and C.”

Reference will now be made to FIG. 3, which depicts one embodiment of a wireless communication apparatus 300 such as the AP 102 or the STA 108 of FIG. 1. The wireless communication apparatus 300 may include a wireless communication system such as radio system 302 (which may correspond to radio system 104 of AP 102, or radio system 110 of STA 108). Radio system 302 may include radio front-end module (FEM) circuitry 304, radio integrated circuit (radio IC) 306 and baseband processor or processing circuitry 308. The radio IC 306 and baseband processor 308 may be positioned on the same integrated circuit card (IC) 312, although embodiments are not so limited. The radio IC 306 and FEM circuitry 304 may together be referred to as a transceiver system 307, and it is to be understood that radio IC 306 and FEM circuitry 304 may, in one embodiment, have their functionality integrated, although embodiments are not so limited. The wireless communication apparatus 300 as shown includes both Wi-Fi functionality and LP-WU functionality, although embodiments are not so limited. LP-WUR/LP-WU may refer to Medium Access Control Layer and Physical Layer specifications in accordance with efforts within the Institute of Electrical and Electronics Engineers (IEEE)'s regarding a LP-WUR standard/802.11ba standard. In the shown instance of a wireless communication apparatus 300 including an AP, the LP-WU functionality may not necessarily include functionality necessary to receive and decode wake-up payloads to wake up a main radio system in the AP, but would include the ability of the radio system to transmit wake-up payloads addressed to one or more STAs to wake up respective main radio systems within those STAs. In the shown instance of a wireless communication apparatus 300 including a STA, the LP-WU functionality would include functionality necessary to receive and decode LP-WU packets to wake up a main radio system in the AP, but may not necessarily include the ability of the radio system to transmit LP-WU packets addressed to one or more STAs to wake up respective main radio systems within those STAs.

In FIG. 3, it is further to be noted that the representation of a single antenna may be interpreted to mean one or more antennas. Furthermore, although FIG. 3 shows a single radio IC block 306, a single FEM circuitry block 304 and a single baseband circuitry block 308, where each of the above blocks could include both Wi-Fi and LP-WU functionality, these blocks are to be viewed as representing the possibility of one or more circuitry blocks, where potentially one set of distinct circuitry blocks, for example, a distinct FEM circuitry, a distinct radio IC, and/or a distinct LP-WU baseband circuitry would work to provide the noted LP-WU functionality. In the alternative, such functionality could be integrated either in part or in whole within the Wi-Fi circuitry. In a further alternative, components providing LP-WU functionality could be provided, according to some demonstrative embodiments, within circuitry blocks positioned off of the IC 312 or radio system 302, for example adjacent the application processor 311. Also, as used herein, “processing circuitry” or “processor” may include one or more distinctly identifiable processor blocks.

FEM circuitry 304 may include both Wi-Fi functionality (which would allow the processing of Wi-Fi signals) and LP-WU functionality (which, in the case of the FEM, would mean at least the ability to transmit LP-WU packets). The FEM circuitry 304 may include a receive signal path comprising circuitry configured to operate on Wi-Fi signals received from one or more antennas 301, to amplify the received signals and to provide the amplified versions of the received signals to the radio IC 306 for further processing. The FEM may further include a receive signal path comprising circuitry configured to operate on LP-WU signals received from one or more antennas 301, to amplify the received signals and to provide the amplified versions of the received signals to the radio IC 306 for further processing. FEM circuitry 304 may also include a transmit signal path which may include circuitry configured to amplify Wi-Fi signals provided by the radio IC 306 for wireless transmission by one or more of the antennas 301. FEM circuitry 304 may also include a transmit signal path which may include circuitry configured to amplify LP-WU signals provided by the radio IC 306 for wireless transmission by one or more of the antennas 301. The antennas may include directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result.

Radio IC 306 may include both Wi-Fi and LP-WU functionality, and may include therein a distinct LP-WU radio to process LP-WU signals. In the case of an STA, the radio IC 306 would be adapted to at least process/decode received LP-WU signals, and may optionally also be adapted to process LP-WU signals that are to be transmitted, although embodiments are not so limited. In the case of an AP, the radio IC 306 would be adapted to at least process LP-WU signals for transmission, and may optionally also be adapted to process LP-WU signals that are received, although embodiments are not so limited. Radio IC 306 as shown may include a receive signal path which may include circuitry to down-convert Wi-Fi signals, and LP-WU signals, received from the FEM circuitry 304 and provide baseband signals to baseband processor 308. The radio IC 306 may also include a transmit signal path which may include circuitry to up-convert baseband signals provided by the baseband processor 308 and provide RF output signals to the FEM circuitry 304 for subsequent wireless transmission by the one or more antennas 301.

Baseband processing circuitry 308 may include processing circuitry that provides Wi-Fi functionality, and processing circuitry that provides at least transmit LP-WU functionality. In the instant description, the baseband processing circuitry 308 may include a memory 309, such as, for example, a set of RAM arrays in a Fast Fourier Transform or Inverse Fast Fourier Transform block (not shown) of the baseband processor 308. Processing circuitry 310, in the case of a STA, may include control logic to process the signals received from the receive signal path of the radio IC 306, such as Wi-Fi signals and LP-WU signals. Processing circuitry 310, in the case of an AP, may include control logic to process the signals received from the receive signal path of the radio IC 306, such as Wi-Fi signals and optionally LP-WU signals. Baseband processing circuitry 308 may also include control logic to generate baseband signals for the transmit signal path of the radio IC 306. Processing circuitry 310, in the case of a STA, may include control logic to generate the signals to cause the signals to be sent to the transmit signal path of the radio IC 306, such as Wi-Fi signals, and, optionally, LP-WU signals, for transmission by the antennas 301. Processing circuitry 310, in the case of an AP, may also include control logic to generate signals to cause the signals to be sent to the transmit signal path of the radio IC 306, such as Wi-Fi signals and also LP-WU signals, for transmission by the antennas 301. Processing circuitry 310 and may further include physical layer (PHY) and medium access control layer (MAC) circuitry, and may further interface with application processor 311 for generation and processing of the baseband signals and for controlling operations of the radio IC 306. In the case of an AP, baseband processing circuitry 308 may be adapted to generate and as a result cause transmission of both Wi-Fi and LP-WU signals, such as the generation of LP-WU packets similar to packet 200 of FIG. 2.

In some demonstrative embodiments, the front-end module circuitry 304, the radio IC 306, and baseband processor 308 may be provided on a single radio card, such as radio system 302. In some other embodiments, the one or more antennas 301, the FEM circuitry 304 and the radio IC 306 may be provided on a single radio card. In some other embodiments, the radio IC 306 and the baseband processor 308 may be provided on a single chip or integrated circuit (IC), such as IC 312.

In some demonstrative embodiments, the wireless communication apparatus 300 of FIG. 3 may include a Wi-Fi radio system and may be configured for Wi-Fi communications, although the scope of the embodiments is not limited in this respect. In some of these embodiments, the wireless communication apparatus 300 may be configured to receive and transmit OFDM or OFDMA communication signals over a multicarrier communication channel.

In some other embodiments, the wireless communication apparatus 300 may be configured to transmit and receive signals transmitted using one or more modulation techniques other than OFDM or OFDMA, such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, and On-Off Keying (OOK), although the scope of the embodiments is not limited in this respect.

In some demonstrative embodiments, the wireless communication apparatus 300 may include other radio systems, such as a cellular radio system 316 configured for cellular (e.g., 3GPP such as LTE, LTE-Advanced or 5G communications).

In some IEEE 802.11 embodiments, the wireless communication apparatus 300 may be configured for communication over various channel bandwidths including bandwidths having center frequencies of 900 MHz, 2.03125 MHz, 2.4 GHz, 4.0625 MHz, 5 GHz, 8.28125 MHz and bandwidths of less than 5 MHz, or of about 1 MHz, 2 MHz, 2.5 MHz, 4 MHz, 5 MHz, 8 MHz, 10 MHz, 16 MHz, 20 MHz, 40 MHz, 80 MHz (with contiguous bandwidths) or 80+80 MHz (160 MHz) (with non-contiguous bandwidths), or any combination of the above frequencies or bandwidths, or any frequencies or bandwidths between the ones expressly noted above. In some demonstrative embodiments, a 320 MHz channel bandwidth may be used. The scope of the embodiments is not limited with respect to the above center frequencies however.

Referring still to FIG. 3, in some demonstrative embodiments, wireless communication apparatus 300 may further include an input unit 318, an output unit 319, a memory unit 315. Wireless communication apparatus 300 may optionally include other suitable hardware components and/or software components. In some demonstrative embodiments, some or all of the components of wireless communication apparatus 300 may be enclosed in a common housing or packaging, and may be interconnected or operably associated using one or more wired or wireless links. In other embodiments, components of wireless communication apparatus 300 may be distributed among multiple or separate devices.

In some demonstrative embodiments, application processor 311 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Application processor 311 may execute instructions, for example, of an Operating System (OS) of wireless communication apparatus 300 and/or of one or more suitable applications.

In some demonstrative embodiments, input unit 318 may include, for example, one or more input pins on a circuit board, a keyboard, a keypad, a mouse, a touch-screen, a touch-pad, a track-ball, a stylus, a microphone, or other suitable pointing device or input device. Output unit 319 may include, for example, one or more output pins on a circuit board, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative embodiments, memory 315 may include, for example, a Random-Access Memory (RAM), a Read-Only Memory (ROM), a Dynamic RAM (DRAM), a Synchronous DRAM (SD-RAM), a flash memory, a volatile memory, a non-volatile memory, a cache memory, a buffer, a short-term memory unit, a long-term memory unit, or other suitable memory units.

Storage unit 317 may include, for example, a hard disk drive, a floppy disk drive, a Compact Disk (CD) drive, a CD-ROM drive, a DVD drive, or other suitable removable or non-removable storage units. Memory unit 315 and/or storage unit 317, for example, may store data processed by wireless communication apparatus 300.

Referring still to the demonstrative embodiment of FIG. 3, circuitry may exist within FEM 304, within radio IC 306 and within baseband processing circuitry 308 that provide LP-WU functionality, such as LP-WU transmit only functionality, or LP-WU transmit and receive functionality. According to some other embodiments, the apparatus 300 shown in FIG. 3 may have more than one FEM or radio IC or baseband circuitry to provide the respective Wi-Fi plus LP-WU functionalities. Considering the wireless communication apparatus 300 of FIG. 3, a “main radio system” of the apparatus 300, when the apparatus is a STA, corresponds to those parts of the radio system 302 that provide the Wi-Fi functionality, as opposed to the wake-up radio system which provides the LP-WU functionality.

Referring next to FIG. 4, an OFDMA packet structure 402 is shown for a 20 MHz 9 RU 26 tone bandwidth transmission in conformance with 802.11ax, suggesting that LP-WU symbols are modulating OFDMA symbols in the central 26 tone RU, RU5, as noted above with respect to the second embodiment (the wake-up receiver using as the operational CP length the CP length of the last packet transmission from its main radio) and third embodiment (the wake-up receiver determining its own operational CP length).

As shown in FIG. 4, according to one embodiment, a LP-WU signal 408 may be multiplexed onto the OFDMA signal that is allocated to the central 26 tone RU as shown, that is, RU5, with adjacent RUs, that is RUs 4 and 6 possibly nulled to avoid adjacent interference, although embodiments are not so limited. The packet structure 402 further includes a preamble 406 also spanning the entire bandwidth of the transmission, that is 20 MHz, the preamble including a legacy preamble and a HE preamble in conformance with 802.11ax. Preamble 406 may include a legacy short-training field (L-STF), a legacy long training field (L-LTF), and a legacy signal (L-SIG) field (not shown), and an HE preamble in compliance with 802.11ax. According to other embodiments, preamble 406 may be in compliance with another communication standard, such as Bluetooth. In some demonstrative embodiments, a LP-WUR may ignore the legacy preamble 406. The legacy preamble would allow legacy 802.11 STAs to detect the beginning of the compound packet (that is, packet including the first signal multiplexed into the second signal) through L-STF, and the end of the packet through information within the L-SIG, while the HE preamble would allow HE STAs to detect among other things whether the compound packet includes HE signals. The HE preamble may also include one or more STA identifiers for the STAs that are to process the OFDMA signals in the assigned RUs of the OFDMA packet. The LP-WU receiver would decode an absence of an OFDMA modulated data signal in the predetermined RU, such as RU5, as a bit value of “0”. A set of OFDMA signals thus allocated to corresponding predetermined RUs of successive transmissions, such as corresponding RU5's of successive OFDMA signal transmissions, interspersed with some nulled versions of RU5, would present a sequence of bit values of 1's and 0's that would be decoded on the LP-WU receiver side as an OOK LP-WU packet. This packet could be used to cause a wake-up of the main radio, such as an 802.11ax radio, such that this main radio could then demodulate subsequent OFDMA signals after waking up, from the transmitter that sent the multiplexed OFDMA signal including the OOK LP-WU signal, and/or from other transmitters. As can be seen from FIG. 4, an LP-WU signal multiplexed into an OFDMA packet structure would need to be aligned to the OFDMA signals within the packet structure, and would as a result be using the same CP length as that used for the OFDMA signals, to the extent that the CP length of OFDMA signals is subject to change from transmission to transmission, the LP-WUR would need to be able to determine which CP length to use to decode the LP-WU signal.

According to some demonstrative embodiments, a wireless communication device, such as for example baseband processor 308 of FIG. 3, comprises a memory, such as, for example, memory 309, and processing circuitry, such as processing circuitry 310 including logic. The processing circuitry is to decode a wake-up payload, such as wake-up payload 208 of a LP-WU packet 200 of FIG. 2, when a main radio associated with the device is in a sleep state, using an operational CP length for the packet. The processor circuitry would use an operational CP length that is either fixed for the system, that is a CP length used for a last packet transmission by the main radio, or that is a selected CP length determined by itself, for example, determined though hypothesis testing using cross-correlation as will be explained below. The processing circuitry would then be able to cause a wake-up of the main radio based on the wake-up payload to allow the main radio to process a subsequent packet after waking up. A modulation rate used for the wake-up payload may be lower than a lowest modulation rate used for the subsequent packet. For example, where the subsequent packet lowest possible modulation rate supported by the main radio is binary phase shift keying (BPSK, used for example for the legacy preamble portion of an OFDM or OFDMA packet in 802.11n or 802.11ax), the wake-up payload may be OOK modulated according to some demonstrative embodiments.

For the first embodiment involving the use of a fixed CP length for the operational CP length, according to one embodiment, the fixed CP length may be equal to a longest CP length supported at the main radio. By way of example, where the main radio, which is to decode the subsequent packet, is compliant with 802.11ax, the longest possible CP length would be 3.2 μsec as prescribed by the amendment/protocol.

For the second embodiment involving the use of the CP length for the last packet transmission from the main radio as the operational CP length, for example where the main radio, which is to decode the subsequent packet, is compliant with 802.11n or 802.11ax, the CP length used for the last packet transmission may be one of 0.4 μsec, 0.8 μsec, 1.6 μsec, and 3.2 μsec. According to one embodiment, after the last packet transmission from the main radio, for example, the main radio 110 of STA 108 of FIG. 1, the main radio may transmit a communication including an indication that the main radio is to go into a sleep state, and that a wake-up receiver, such as the LP-WUR 112 of STA 108, would be monitoring the air medium subsequently. In such a case, the wireless communication system receiving the last packet communication, such as AP 102 of FIG. 1, may transmit a wake-up payload, such as for example a LP-WU payload, to the wake-up receiver of the device having the main radio, such as to wake-up receiver 112 of STA 108. The wake-up packet may be a LP-WU packet such as LP-WU 128 of FIG. 1. The wake-up packet may have a CP length based on a CP length used for the last packet transmission by the main radio. In some embodiments, the main radio, such as radio 110 of STA 108, may include a memory having a buffer (not shown), wherein the buffer is to receive and store the CP length used for the last packet transmission.

According to the third embodiment, where the wake-up receiver is to determine a selected CP length as the operational CP length, the processing circuitry of the wake-up receiver, such as, for example, LP-WUR 112 of STA 108 in FIG. 1, or processing circuitry 310 of FIG. 3, may determine the selected CP length as the operational CP length by first generating a plurality of sets of bits, each set of bits of the plurality of sets of bits corresponding to one of a plurality of local wake-up preambles of the device including the processing circuitry, such as local wake-up preambles of baseband processor 308 including the processing circuitry 310 in FIG. 3. Each of the local wake-up preambles may be associated with a respective one of a plurality of distinct CP lengths. These local wake-up preambles would not necessarily be generated for transmission, but generated by the processing circuitry in order to allow hypothesis testing through cross-correlation. Where there is a closest correspondence between a local wake-up preamble associated with a given CP length on the one hand, and the local wake-up preamble, the cross-correlation would yield a maximum convolution value which would signal that the given CP length should be the selected CP length.

According to some demonstrative embodiments, the wake-up payload may have a pulse bandwidth of 4.06 MHz; the frequency spacing between tones in the wake-up payload may be 312.5 kHz; and the wake-up portion may include 13 tones per symbol. According to some demonstrative embodiments, the processing circuitry may further be adapted to cause transmission of wake-up payloads to other devices.

Reference has been made to FIGS. 1, 2, 3 and 4 in order to describe some demonstrative embodiments, although it is to be noted that embodiments are not limited to what is described herein with respect to those figures, or any of the other figures included herein.

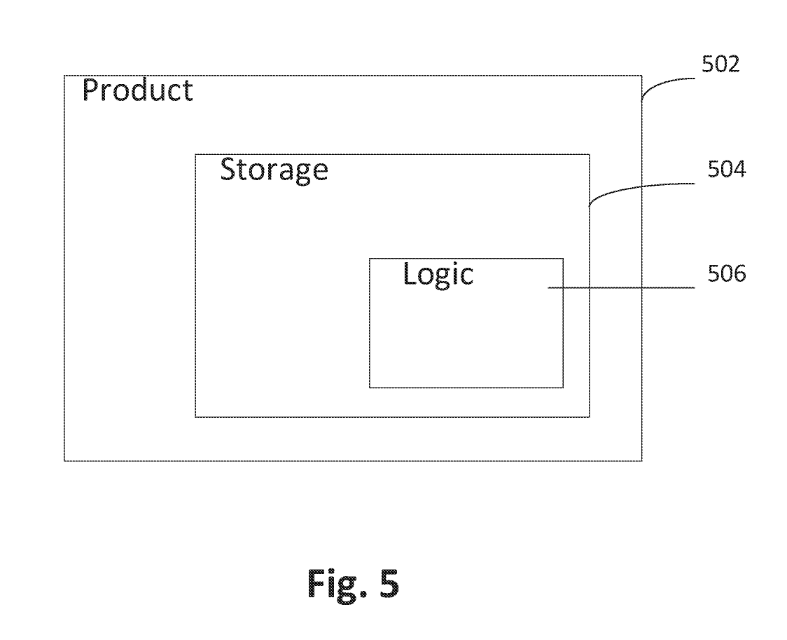

FIG. 5 illustrates a product of manufacture 500, in accordance with some demonstrative embodiments. Product 500 may include one or more tangible computer-readable non-transitory storage media 502, which may include computer-executable instructions, e.g., implemented by logic 504, operable to, when executed by at least one computer processor, cause the at least one computer processor to implement one or more operations at a STA or an AP, and/or to perform one or more operations described above with respect to FIGS. 1, 2, 3 and 4, and/or one or more operations described herein. The phrase “non-transitory machine-readable medium” is directed to include all computer-readable media, with the sole exception being a transitory propagating signal.

In some demonstrative embodiments, product 500 and/or storage media 502 may include one or more types of computer-readable storage media capable of storing data, including volatile memory, non-volatile memory, removable or non-removable memory, erasable or non-erasable memory, writeable or re-writeable memory, and the like. For example, storage media 502 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 504 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 504 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

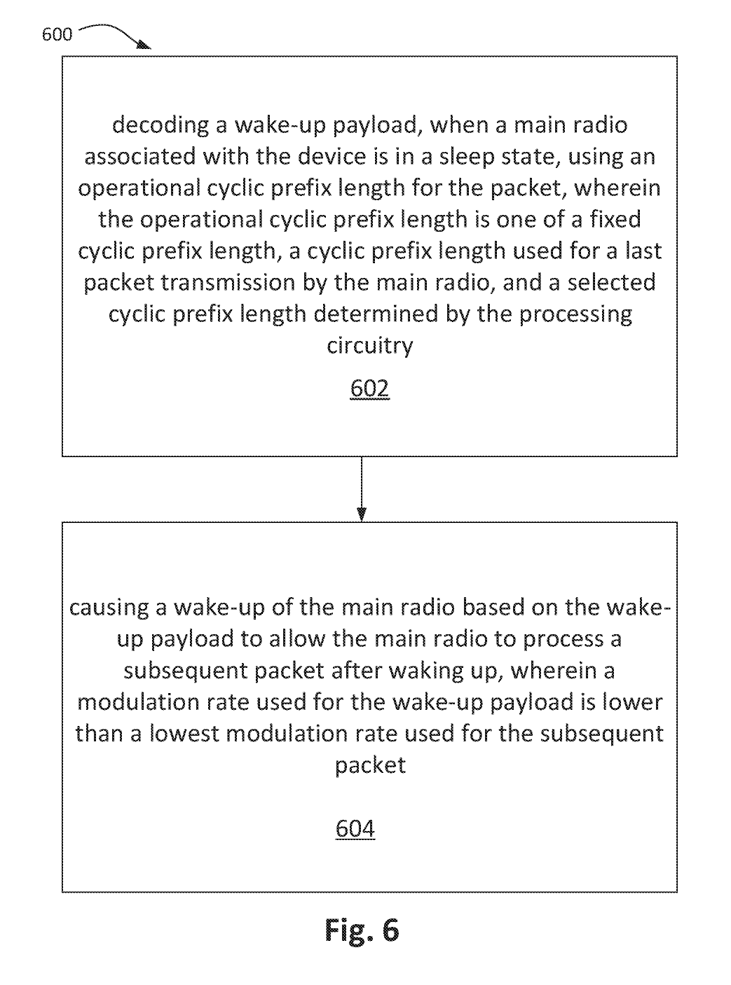

FIG. 6 illustrates a method 600 of using a wireless communication system in accordance with some demonstrative embodiments. The method 600 may begin with operation 602, which includes decoding a wake-up payload, when a main radio associated with the device is in a sleep state, using an operational cyclic prefix length for the packet, wherein the operational cyclic prefix length is one of a fixed cyclic prefix length, a cyclic prefix length used for a last packet transmission by the main radio, and a selected cyclic prefix length determined by the processing circuitry. At operation 604, the method includes causing a wake-up of the main radio based on the wake-up payload to allow the main radio to process a subsequent packet after waking up. A modulation rate used for the wake-up payload may be lower than a lowest modulation rate used for the subsequent packet.

Some demonstrative embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. Those instructions may then be read and executed by one or more processors to cause the wireless communication system of FIG. 3 to perform the methods and/or operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

### EXAMPLES

The following examples pertain to further embodiments.

Example 1 includes a wireless communication device comprising a memory, and processing circuitry including logic, the processing circuitry to: decode a wake-up payload, when a main radio associated with the device is in a sleep state, using an operational cyclic prefix length for the packet, wherein the operational cyclic prefix length is one of a fixed cyclic prefix length, a cyclic prefix length used for a last packet transmission by the main radio, and a selected cyclic prefix length determined by the processing circuitry; cause a wake-up of the main radio based on the wake-up payload to allow the main radio to process a subsequent packet after waking up.

Example 2 includes the subject matter of Example 1, and optionally, wherein a modulation rate used for the wake-up payload is lower than a lowest modulation rate used for the subsequent packet.

Example 3 includes the subject matter of Example 1, and optionally, wherein the fixed cyclic prefix length is equal to a longest cyclic prefix length supported by the main radio.

Example 4 includes the subject matter of Example 3, and optionally, wherein the longest possible cyclic prefix length is 3.2 μsec.

Example 5 includes the subject matter of Example 1, and optionally, wherein the cyclic prefix length used for the last packet transmission is one of 0.4 μsec, 0.8 μsec, 1.6 μsec, and 3.2 μsec.

Example 6 includes the subject matter of any one of Examples 1 and 5, wherein the memory includes a buffer, and wherein the buffer is to receive and store the cyclic prefix length used for the last packet transmission.

Example 7 includes the subject matter of Example 1, and optionally, wherein the wake-up payload includes a wake-up preamble, and wherein the processing circuitry is further to determine the selected cyclic prefix length by: generating a plurality of local preambles, each of the plurality of local preambles being associated with a respective cyclic prefix length of a plurality of distinct cyclic prefix lengths; cross correlating the wake-up preamble of the wake-up payload with each of the local preambles; and selecting, as the operational cyclic prefix length, a cyclic prefix length of the plurality of distinct cyclic prefix lengths that is associated with a local wake-up preamble of the plurality of local wake-up preambles having a highest cross correlation value with the wake-up preamble of the wake-up payload.

Example 8 includes the subject matter of any one of Examples 1-3, 5 and 7, wherein the modulation rate used for the wake-up payload includes an On-Off-Keying (OOK) modulation rate.

Example 9 includes the subject matter of Example 8, and optionally, wherein the wake-up payload is part of a wake-up packet, the wake-up packet further including a legacy preamble portion, and wherein: the legacy preamble portion includes a legacy short training field (L-STF), a legacy long training field (L-LTF) and a legacy signal field (L-SIG); and the wake-up payload includes a wake-up preamble, a medium access control (MAC) header including an address of the device, a frame body and a frame check sequence (FCS) including cyclic redundancy check (CRC) information.

Example 10 includes the subject matter of Example 9, and optionally, wherein: the wake-up portion has a pulse bandwidth of 2.03 MHz or 4.06 MHz; a frequency spacing between tones in the wake-up portion is 78.125 kHz or 312.5 kHz; and the wake-up portion includes 26 tones or 13 tones per symbol.

Example 11 includes the subject matter of any one of Examples 1-3, 5 and 7, further including a radio system including a baseband processor including the memory and the processing circuitry, and a transceiver including a radio integrated circuit (radio IC) coupled to the baseband processor, and radio front end module circuitry coupled to the radio integrated circuit.

Example 12 includes the subject matter of Example 11, and optionally, further including one or more antennas coupled to the front-end module of the radio system.

Example 13 includes the subject matter of any one of Examples 1-3, 5 and 7, wherein the processing circuitry is further to cause transmission of wake-up payloads to other devices.

Example 14 includes the subject matter of any one of Examples 1-3, 5 and 7, wherein the wake-up payload is in conformance with an Institute of Electrical and Electronics Engineers 802.11ba wireless communication protocol, and the subsequent packet is a Wi-Fi packet.

Example 15 includes a product comprising one or more tangible computer-readable non-transitory storage media comprising computer-executable instructions operable to, when executed by at least one computer processor, cause the at least one computer processor to implement operations at a wireless communication device, the operations comprising: decoding a wake-up payload, when a main radio associated with the device is in a sleep state, using an operational cyclic prefix length for the packet, wherein the operational cyclic prefix length is one of a fixed cyclic prefix length, a cyclic prefix length used for a last packet transmission by the main radio, and a selected cyclic prefix length determined by the processing circuitry; causing a wake-up of the main radio based on the wake-up payload to allow the main radio to process a subsequent packet after waking up.

Example 16 includes the subject matter of Example 15, and optionally, wherein a modulation rate used for the wake-up payload is lower than a lowest modulation rate used for the subsequent packet.

Example 17 includes the subject matter of any one of Examples 15 and 16, wherein the fixed cyclic prefix length is equal to a longest cyclic prefix length supported by the main radio.

Example 18 includes the subject matter of Example 17, and optionally, wherein the longest possible cyclic prefix length is 3.2 μsec.

Example 19 includes the subject matter of Example 15, and optionally, wherein the cyclic prefix length used for the last packet transmission is one of 0.4 μsec, 0.8 μsec, 1.6 μsec, and 3.2 μsec.

Example 20 includes the subject matter of any one of Examples 15 and 19, wherein the operations further include receiving from the main radio, and storing in a buffer, the cyclic prefix length used for the last packet transmission.

Example 21 includes the subject matter of Example 15, and optionally, wherein the wake-up payload includes a wake-up preamble, and wherein the operations include determining the selected cyclic prefix length by: generating a plurality of local preambles, each of the plurality of local preambles being associated with a respective cyclic prefix length of a plurality of distinct cyclic prefix lengths; cross correlating the wake-up preamble of the wake-up payload with each of the local preambles; and selecting, as the operational cyclic prefix length, a cyclic prefix length of the plurality of distinct cyclic prefix lengths that is associated with a local wake-up preamble of the plurality of local wake-up preambles having a highest cross correlation value with the wake-up preamble of the wake-up payload.

Example 22 includes the subject matter of any one of Examples 15, 16, 19 and 21, wherein the modulation rate used for the wake-up payload includes an On-Off-Keying (OOK) modulation rate.

Example 23 includes the subject matter of Example 22, and optionally, wherein the wake-up payload is part of a wake-up packet, the wake-up packet further including a legacy preamble portion, and wherein: the legacy preamble portion includes a legacy short training field (L-STF), a legacy long training field (L-LTF) and a legacy signal field (L-SIG); and the wake-up payload includes a wake-up preamble, a medium access control (MAC) header including an address of the device, a frame body and a frame check sequence (FCS) including cyclic redundancy check (CRC) information.

Example 24 includes the subject matter of Example 23, and optionally, wherein: the wake-up portion has a pulse bandwidth of 2.03 MHz or 4.06 MHz; a frequency spacing between tones in the wake-up portion is 78.125 kHz or 312.5 kHz; and the wake-up portion includes 26 tones or 13 tones per symbol.

Example 25 includes the subject matter of any one of Examples 15, 16, 19 and 21, wherein the operations further include causing transmission of wake-up payloads to other devices.

Example 26 includes the subject matter of any one of Examples 15, 16, 19 and 21, wherein the wake-up payload is in conformance with an Institute of Electrical and Electronics Engineers 802.11ba wireless communication protocol, and the subsequent packet is a Wi-Fi packet.

Example 27 includes a method to be performed at a wireless communication device, the method comprising: decoding a wake-up payload, when a main radio associated with the device is in a sleep state, using an operational cyclic prefix length for the packet, wherein the operational cyclic prefix length is one of a fixed cyclic prefix length, a cyclic prefix length used for a last packet transmission by the main radio, and a selected cyclic prefix length determined by the processing circuitry; causing a wake-up of the main radio based on the wake-up payload to allow the main radio to process a subsequent packet after waking up.

Example 28 includes the method of Example 27, and optionally, wherein a modulation rate used for the wake-up payload is lower than a lowest modulation rate used for the subsequent packet.

Example 29 includes the method of Example 27, and optionally, wherein the fixed cyclic prefix length is equal to a longest cyclic prefix length supported by the main radio.

Example 30 includes the method of Example 29, and optionally, wherein the longest possible cyclic prefix length is 3.2 μsec.

Example 31 includes the method of Example 27, and optionally, wherein the cyclic prefix length used for the last packet transmission is one of 0.4 μsec, 0.8 μsec, 1.6 μsec, and 3.2 μsec.

Example 32 includes the subject matter of any one of Examples 27 and 31, wherein the method further includes receiving from the main radio, and storing in a buffer, the cyclic prefix length used for the last packet transmission.

Example 33 includes the method of Example 27, and optionally, wherein the wake-up payload includes a wake-up preamble, and wherein the method further includes determining the selected cyclic prefix length by: generating a plurality of local preambles, each of the plurality of local preambles being associated with a respective cyclic prefix length of a plurality of distinct cyclic prefix lengths; cross correlating the wake-up preamble of the wake-up payload with each of the local preambles; selecting, as the operational cyclic prefix length, a cyclic prefix length of the plurality of distinct cyclic prefix lengths that is associated with a local wake-up preamble of the plurality of local wake-up preambles having a highest cross correlation value with the wake-up preamble of the wake-up payload.

Example 34 includes the subject matter of any one of Examples 27-29, 31 and 33, wherein the modulation rate used for the wake-up payload includes an On-Off-Keying (OOK) modulation rate.

Example 35 includes the method of Example 34, and optionally, wherein the wake-up payload is part of a wake-up packet, the wake-up packet further including a legacy preamble portion, and wherein: the legacy preamble portion includes a legacy short training field (L-STF), a legacy long training field (L-LTF) and a legacy signal field (L-SIG); and the wake-up payload includes a wake-up preamble, a medium access control (MAC) header including an address of the device, a frame body and a frame check sequence (FCS) including cyclic redundancy check (CRC) information.

Example 36 includes the method of Example 35, and optionally, wherein: the wake-up payload has a pulse bandwidth of 4.06 MHz; a tone spacing between tones in the wake-up payload is 312.5 kHz; and the wake-up payload includes 13 tones per symbol.

Example 37 includes the subject matter of any one of Examples 27-29, 31 and 33, further including receiving the wake-up payload through one or more antennas.

Example 38 includes the subject matter of any one of Examples 27-29, 31 and 33, further including causing transmission of wake-up payloads to other devices.

Example 39 includes the subject matter of any one of Examples 27-29, 31 and 33, wherein the wake-up payload is in conformance with an Institute of Electrical and Electronics Engineers 802.11ba wireless communication protocol, and the subsequent packet is a Wi-Fi packet.

Example 40 includes a wireless communication device comprising: means for decoding a wake-up payload, when a main radio associated with the device is in a sleep state, using an operational cyclic prefix length for the packet, wherein the operational cyclic prefix length is one of a fixed cyclic prefix length, a cyclic prefix length used for a last packet transmission by the main radio, and a selected cyclic prefix length determined by the processing circuitry; means for causing a wake-up of the main radio based on the wake-up payload to allow the main radio to process a subsequent packet after waking up.

Example 41 includes the subject matter of Example 40, and optionally, wherein the fixed cyclic prefix length is equal to a longest cyclic prefix length supported by the main radio.

Example 42 includes the subject matter of Example 41, and optionally, wherein the longest possible cyclic prefix length is 3.2 μsec.

Example 43 includes the subject matter of Example 40, and optionally, wherein the cyclic prefix length used for the last packet transmission is one of 0.4 μsec, 0.8 μsec, 1.6 μsec, and 3.2 μsec.

Example 44 includes the subject matter of any one of Examples 40 and 43, further including means for receiving from the main radio, and storing in a buffer, the cyclic prefix length used for the last packet transmission.

Example 45 includes the subject matter of Example 40, and optionally, wherein the wake-up payload includes a wake-up preamble, and further including means for determining the selected cyclic prefix length by: generating a plurality of local preambles, each of the plurality of local preambles being associated with a respective cyclic prefix length of a plurality of distinct cyclic prefix lengths; cross correlating the wake-up preamble of the wake-up payload with each of the local preambles; selecting, as the operational cyclic prefix length, a cyclic prefix length of the plurality of distinct cyclic prefix lengths that is associated with a local wake-up preamble of the plurality of local wake-up preambles having a highest cross correlation value with the wake-up preamble of the wake-up payload.

Example 46 includes the subject matter of any one of Examples-43 and 45 wherein the modulation rate used for the wake-up payload includes an On-Off-Keying (OOK) modulation rate.

Example 47 includes the subject matter of Example 46, and optionally, wherein the wake-up payload is part of a wake-up packet, the wake-up packet further including a legacy preamble portion, and wherein: the legacy preamble portion includes a legacy short training field (L-STF), a legacy long training field (L-LTF) and a legacy signal field (L-SIG); and the wake-up payload includes a wake-up preamble, a medium access control (MAC) header including an address of the device, a frame body and a frame check sequence (FCS) including cyclic redundancy check (CRC) information.

Example 48 includes the subject matter of Example 47, and optionally, wherein: the wake-up payload has a pulse bandwidth of 4.06 MHz; a tone spacing between tones in the wake-up payload is 312.5 kHz; and the wake-up payload includes 13 tones per symbol.

Example 49 includes the subject matter of any one of Examples 40-43 and 45, further including receiving the wake-up payload through one or more antennas.

Example 50 includes the subject matter of any one of Examples 40-43 and 45, further including causing transmission of wake-up payloads to other devices.

Example 51 includes the subject matter of any one of Examples 40-43 and 45, wherein the wake-up payload is in conformance with an Institute of Electrical and Electronics Engineers 802.11ba wireless communication protocol, and the subsequent packet is a Wi-Fi packet.

Example 52 includes a wireless communication device comprising a memory, and processing circuitry including logic, the processing circuitry to: decode a communication from a main radio associated with another device including an indication that the main radio is to go into a sleep state; cause transmission of a wake-up payload to a wake-up radio of said another device, the wake-up payload having a cyclic prefix length based on a cyclic prefix length used for a last packet transmission by said another device, the wake-up payload to wake up the main radio.

Example 53 includes the subject matter of Example 52, and optionally, wherein the cyclic prefix length used for the last packet transmission is one of 0.4 μsec, 0.8 μsec, 1.6 μsec, and 3.2 μsec.

Example 54 includes the subject matter of Example 52, and optionally, wherein the modulation rate used for the wake-up payload includes an On-Off-Keying (OOK) modulation rate.

Example 55 includes the subject matter of any one of Examples 52-54 wherein the wake-up payload is part of a wake-up packet, the wake-up packet further including a legacy preamble portion, and wherein: the legacy preamble portion includes a legacy short training field (L-STF), a legacy long training field (L-LTF) and a legacy signal field (L-SIG); and the wake-up payload includes a wake-up preamble, a medium access control (MAC) header including an address of the device, a frame body and a frame check sequence (FCS) including cyclic redundancy check (CRC) information.

Example 56 includes the subject matter of Example 55, and optionally, wherein: the wake-up portion has a pulse bandwidth of 2.03 MHz or 4.06 MHz; a frequency spacing between tones in the wake-up portion is 78.125 kHz or 312.5 kHz; and the wake-up portion includes 26 tones or 13 tones per symbol.

Example 57 includes the subject matter of any one of Examples 52-54, further including a radio system including a baseband processor including the memory and the processing circuitry, and a transceiver including a radio integrated circuit (radio IC) coupled to the baseband processor, and radio front end module circuitry coupled to the radio integrated circuit.

Example 58 includes the subject matter of Example 57, and optionally, further including one or more antennas coupled to the front-end module of the radio system.

Example 59 includes the subject matter of any one of Examples 52-54, wherein the processing circuitry is further to decode wake-up payloads sent by other devices.

Example 60 includes the subject matter of any one of Examples 52-54, wherein the wake-up payload is in conformance with an Institute of Electrical and Electronics Engineers 802.11ba wireless communication protocol, and the subsequent packet is a Wi-Fi packet.

Example 61 includes a method to be performed at a wireless communication device including: decoding a communication from a main radio associated with another device including an indication that the main radio is to go into a sleep state; causing transmission of a wake-up payload to a wake-up radio of said another device, the wake-up payload having a cyclic prefix length based on a cyclic prefix length used for a last packet transmission by said another device, the wake-up payload to wake up the main radio.

Example 62 includes the method of Example 61, and optionally, wherein the cyclic prefix length used for the last packet transmission is one of 0.4 μsec, 0.8 μsec, 1.6 μsec, and 3.2 μsec.

Example 63 includes the subject matter of any one of Examples 61 and 62, wherein the modulation rate used for the wake-up payload includes an On-Off-Keying (OOK) modulation rate.

Example 64 includes the method of Example 63, and optionally, wherein the wake-up payload is part of a wake-up packet, the wake-up packet further including a legacy preamble portion, and wherein: the legacy preamble portion includes a legacy short training field (L-STF), a legacy long training field (L-LTF) and a legacy signal field (L-SIG); and the wake-up payload includes a wake-up preamble, a medium access control (MAC) header including an address of the device, a frame body and a frame check sequence (FCS) including cyclic redundancy check (CRC) information.

Example 65 includes the method of Example 64, and optionally, wherein: the wake-up portion has a pulse bandwidth of 2.03 MHz or 4.06 MHz; a frequency spacing between tones in the wake-up portion is 78.125 kHz or 312.5 kHz; and the wake-up portion includes 26 tones or 13 tones per symbol.

Example 66 includes the subject matter of any one of Examples 61 and 62, further including decoding wake-up payloads sent by other devices.

Example 67 includes the subject matter of any one of Examples 61 and 62, wherein the wake-up payload is in conformance with an Institute of Electrical and Electronics Engineers 802.11ba wireless communication protocol, and the subsequent packet is a Wi-Fi packet.

Example 68 includes a product comprising one or more tangible computer-readable non-transitory storage media comprising computer-executable instructions operable to, when executed by at least one computer processor, cause the at least one computer processor to implement operations at a wireless communication device, the operations comprising: decoding a communication from a main radio associated with another device including an indication that the main radio is to go into a sleep state; causing transmission of a wake-up payload to a wake-up radio of said another device, the wake-up payload having a cyclic prefix length based on a cyclic prefix length used for a last packet transmission by said another device, the wake-up payload to wake up the main radio.

Example 69 includes the subject matter of Example 68, and optionally, wherein the cyclic prefix length used for the last packet transmission is one of 0.4 μsec, 0.8 μsec, 1.6 μsec, and 3.2 μsec.

Example 70 includes the subject matter of any one of Examples 68 and 69, wherein the modulation rate used for the wake-up payload includes an On-Off-Keying (OOK) modulation rate.

Example 71 includes the subject matter of Example 70, and optionally, wherein the wake-up payload is part of a wake-up packet, the wake-up packet further including a legacy preamble portion, and wherein: the legacy preamble portion includes a legacy short training field (L-STF), a legacy long training field (L-LTF) and a legacy signal field (L-SIG); and the wake-up payload includes a wake-up preamble, a medium access control (MAC) header including an address of the device, a frame body and a frame check sequence (FCS) including cyclic redundancy check (CRC) information.

Example 72 includes the subject matter of Example 71, and optionally, wherein: the wake-up portion has a pulse bandwidth of 2.03 MHz or 4.06 MHz; a frequency spacing between tones in the wake-up portion is 78.125 kHz or 312.5 kHz; and the wake-up portion includes 26 tones or 13 tones per symbol.

Example 73 includes the subject matter of any one of Examples 68-69, wherein the operations further include decoding wake-up payloads sent by other devices.

Example 74 includes the subject matter of any one of Examples 68-69, wherein the wake-up payload is in conformance with an Institute of Electrical and Electronics Engineers 802.11ba wireless communication protocol, and the subsequent packet is a Wi-Fi packet.

An Abstract is provided. It is submitted with the understanding that it will not be used to limit or interpret the scope or meaning of the claims. The following claims are hereby incorporated into the detailed description, with each claim standing on its own as a separate embodiment.

What is claimed is:

1. A wireless communication device comprising a memory, and processing circuitry including logic, the processing circuitry to:
decode a wake-up payload, when a main radio associated with the device is in a sleep state, using an operational cyclic prefix length for the packet, wherein the operational cyclic prefix length is one of a fixed cyclic prefix length, a cyclic prefix length used for a last packet transmission by the main radio, and a selected cyclic prefix length determined by the processing circuitry;
cause a wake-up of the main radio based on the wake-up payload to allow the main radio to process a subsequent packet after waking up.

2. The device of claim 1, wherein the fixed cyclic prefix length is equal to a longest cyclic prefix length supported by the main radio.

3. The device of claim 1, wherein the cyclic prefix length used for the last packet transmission is one of 0.4 μsec, 0.8 μsec, 1.6 μsec, and 3.2 μsec.

4. The device of claim 1, wherein the wake-up payload includes a wake-up preamble, and wherein the processing circuitry is further to determine the selected cyclic prefix length by:
generating a plurality of local preambles, each of the plurality of local preambles being associated with a respective cyclic prefix length of a plurality of distinct cyclic prefix lengths;
cross correlating the wake-up preamble of the wake-up payload with each of the local preambles;
selecting, as the operational cyclic prefix length, a cyclic prefix length of the plurality of distinct cyclic prefix lengths that is associated with a local wake-up preamble of the plurality of local wake-up preambles having a highest cross correlation value with the wake-up preamble of the wake-up payload.

5. The device of claim 1, wherein the modulation rate used for the wake-up payload includes an On-Off-Keying (OOK) modulation rate.

6. The device of claim 1, wherein the wake-up payload is part of a wake-up packet, the wake-up packet further including a legacy preamble portion, and wherein:
the legacy preamble portion includes a legacy short training field (L-STF), a legacy long training field (L-LTF) and a legacy signal field (L-SIG); and
the wake-up payload includes a wake-up preamble, a medium access control (MAC) header including an address of the device, a frame body and a frame check sequence (FCS) including cyclic redundancy check (CRC) information.

7. The device of claim 6, wherein:
the wake-up portion has a pulse bandwidth of 2.03 MHz or 4.06 MHz;
a frequency spacing between tones in the wake-up portion is 78.125 kHz or 312.5 kHz; and
the wake-up portion includes 26 tones or 13 tones per symbol.

8. The device of claim 1, further including a radio system including a baseband processor including the memory and the processing circuitry, and a transceiver including a radio integrated circuit (radio IC) coupled to the baseband processor, and radio front end module circuitry coupled to the radio integrated circuit.

9. The device of claim 8, further including one or more antennas coupled to the front-end module of the radio system.

10. The device of claim 1, wherein the wake-up payload is in conformance with an Institute of Electrical and Electronics Engineers 802.11ba wireless communication protocol, and the subsequent packet is a Wi-Fi packet.

11. A product comprising one or more tangible computer-readable non-transitory storage media comprising computer-executable instructions operable to, when executed by at least one computer processor, cause the at least one computer processor to implement operations at a wireless communication device, the operations comprising:
decoding a wake-up payload, when a main radio associated with the device is in a sleep state, using an operational cyclic prefix length for the packet, wherein the operational cyclic prefix length is one of a fixed cyclic prefix length, a cyclic prefix length used for a last packet transmission by the main radio, and a selected cyclic prefix length determined by the processing circuitry;
causing a wake-up of the main radio based on the wake-up payload to allow the main radio to process a subsequent packet after waking up.

12. The product of claim 11, wherein a modulation rate used for the wake-up payload is lower than a lowest modulation rate used for the subsequent packet.

13. The product of claim 11, wherein the fixed cyclic prefix length is equal to a longest cyclic prefix length supported by the main radio.

14. The product of claim 11, wherein the cyclic prefix length used for the last packet transmission is one of 0.4 μsec, 0.8 μsec, 1.6 μsec, and 3.2 μsec.

15. The product of claim 11, wherein the operations further include receiving from the main radio, and storing in a buffer, the cyclic prefix length used for the last packet transmission.

16. The product of claim 11, wherein the wake-up payload includes a wake-up preamble, and wherein the operations include determining the selected cyclic prefix length by:
generating a plurality of local preambles, each of the plurality of local preambles being associated with a respective cyclic prefix length of a plurality of distinct cyclic prefix lengths;
cross correlating the wake-up preamble of the wake-up payload with each of the local preambles;
selecting, as the operational cyclic prefix length, a cyclic prefix length of the plurality of distinct cyclic prefix lengths that is associated with a local wake-up preamble of the plurality of local wake-up preambles having a highest cross correlation value with the wake-up preamble of the wake-up payload.

17. The product of claim 11, wherein the modulation rate used for the wake-up payload includes an On-Off-Keying (OOK) modulation rate.

18. The product of claim 11, wherein the wake-up payload is part of a wake-up packet, the wake-up packet further including a legacy preamble portion, and wherein:
the legacy preamble portion includes a legacy short training field (L-STF), a legacy long training field (L-LTF) and a legacy signal field (L-SIG); and
the wake-up payload includes a wake-up preamble, a medium access control (MAC) header including an address of the device, a frame body and a frame check sequence (FCS) including cyclic redundancy check (CRC) information.

19. The product of claim 18, wherein:
the wake-up portion has a pulse bandwidth of 2.03 MHz or 4.06 MHz;
a frequency spacing between tones in the wake-up portion is 78.125 kHz or 312.5 kHz; and
the wake-up portion includes 26 tones or 13 tones per symbol.

20. A method to be performed at a wireless communication device, the method comprising:
decoding a wake-up payload, when a main radio associated with the device is in a sleep state, using an operational cyclic prefix length for the packet, wherein the operational cyclic prefix length is one of a fixed cyclic prefix length, a cyclic prefix length used for a last packet transmission by the main radio, and a selected cyclic prefix length determined by the processing circuitry;
causing a wake-up of the main radio based on the wake-up payload to allow the main radio to process a subsequent packet after waking up.

21. The method of claim 20, wherein the fixed cyclic prefix length is equal to a longest cyclic prefix length supported by the main radio.

22. The method of claim 20, wherein the wake-up payload includes a wake-up preamble, and wherein the method further includes determining the selected cyclic prefix length by:
generating a plurality of local preambles, each of the plurality of local preambles being associated with a respective cyclic prefix length of a plurality of distinct cyclic prefix lengths;
cross correlating the wake-up preamble of the wake-up payload with each of the local preambles;
selecting, as the operational cyclic prefix length, a cyclic prefix length of the plurality of distinct cyclic prefix lengths that is associated with a local wake-up preamble of the plurality of local wake-up preambles having a highest cross correlation value with the wake-up preamble of the wake-up payload.

23. A wireless communication device comprising:
means for decoding a wake-up payload, when a main radio associated with the device is in a sleep state, using an operational cyclic prefix length for the packet, wherein the operational cyclic prefix length is one of a fixed cyclic prefix length, a cyclic prefix length used for a last packet transmission by the main radio, and a selected cyclic prefix length determined by the processing circuitry;
means for causing a wake-up of the main radio based on the wake-up payload to allow the main radio to process a subsequent packet after waking up.

24. The device of claim 23, wherein the fixed cyclic prefix length is equal to a longest cyclic prefix length supported by the main radio.

25. The device of claim 23, wherein the wake-up payload includes a wake-up preamble, and further including means for determining the selected cyclic prefix length by:
generating a plurality of local preambles, each of the plurality of local preambles being associated with a respective cyclic prefix length of a plurality of distinct cyclic prefix lengths;
cross correlating the wake-up preamble of the wake-up payload with each of the local preambles;
selecting, as the operational cyclic prefix length, a cyclic prefix length of the plurality of distinct cyclic prefix lengths that is associated with a local wake-up preamble of the plurality of local wake-up preambles having a highest cross correlation value with the wake-up preamble of the wake-up payload.
